(19) United States
(12) Patent Application Publication
(10) Pub. No.: US 2018/0293611 A1
(43) Pub. Date: Oct. 11, 2018

(54) TARGETING CONTENT BASED ON INFERRED USER INTERESTS

(71) Applicant: Facebook, Inc., Menlo Park, CA (US)

(72) Inventors: Sagar Chordia, Redwood City, CA (US); Kai Ren, Belmont, CA (US); Adiitya Pal, San Jose, CA (US); Amac Herdagdelen, Mountain View, CA (US); Tian Wang, Sunnyvale, CA (US)

(21) Appl. No.: 15/482,447

(22) Filed: Apr. 7, 2017

(51) Int. Cl. G06Q 30/02; H04L 29/08; G06N 99/00; G06N 5/04

(52) U.S. Cl. CPC G06Q 30/0251; G06N 5/04; G06N 99/005; H04L 67/306

(57) ABSTRACT

A primary online system infers interests for its users based on interest information in a secondary online system. Users that have user profiles in both the primary online system and the secondary online system are identified, and those associated with a target interest in the secondary online system are selected as part of a training group of that is used to generate an interest inference model that associates information in the training group's user profiles in the primary online system with the target interest. The interest inference model is applied to an input group of users in the primary online system to identify a seed group of users for whom the target interest can be inferred. The primary online system can then target content related to the target interest to an expanded group of users generated based on the seed group.

### BACKGROUND

This disclosure relates generally to online systems, and in particular to targeting content based on inferred user interests in an online system.

An online system allows its users to connect to and to communicate with other users. Users may create profiles on an online system that are tied to their identities and include information about the users, such as interests and demographic information. The users may be individuals or entities such as corporations or charities. Because of the increasing popularity of online systems and the significant amount of user-specific information maintained by online systems, an online system allows users to easily communicate information about themselves to other users and share content with other users. Online systems are able to collect large amounts of information about users that they can then leverage to provide their users with targeted content. Users vary in their engagement with online systems, so much more information can be known for some users relative to other users. This can result in some users receiving less relevant targeted content (and missing out on the opportunity to receive more relevant content).

### SUMMARY

An online system (the “primary” online system) presented targeted content to users based on interests it infers using other information that is available about the users, such as their user characteristics. Users of the primary online system may also be users of another online system (the “secondary” online system) that has accessible interest data that is used by the primary online system for content targeting. However, the primary online system can also use these users of both systems to infer for users that are not users of the secondary online system or have very little information associated with them in the online system. These inferred interests then increase the relevance of targeted content for those users, as well as increase the supply of eligible users for providers of targeted content.

To infer interests for its users, the primary online system first identifies users that have user profiles in both the primary online system and the secondary online system. For a particular target interest, the primary online system selects a training group of users that have the target interest in their user profile on the secondary online system. An interest inference model for the target interest is generated by applying machine learning techniques to the training group users, associating information in the users' profiles in the primary online system with the target interest. The interest inference model is applied to an input group of users that have user profiles in the primary online system to identify those users for whom the target interest can be inferred. Users in the input group have profiles in the primary online system, and some may also have profiles in the secondary online system. Users from the input group for whom the target interest can be inferred become a seed group of users that is used to generate an expanded group of users via cluster-based expansion techniques. The primary online system then targets content related to the target interest to users in the expanded group.

### BRIEF DESCRIPTION OF THE DRAWINGS

FIG. 1 is a block diagram of a system environment in which a primary online system operates, according to one embodiment.

FIG. 2 is a block diagram of a primary online system, according to one embodiment.

FIG. 3 illustrates a training phase and an application phase of the machine-learned interest inference model for inferring user interests in the primary online system based on known interests in the secondary online system, according to one embodiment.

FIG. 4 is a flow chart of a process for presenting content to users of the primary online system based on inferred interests, according to one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

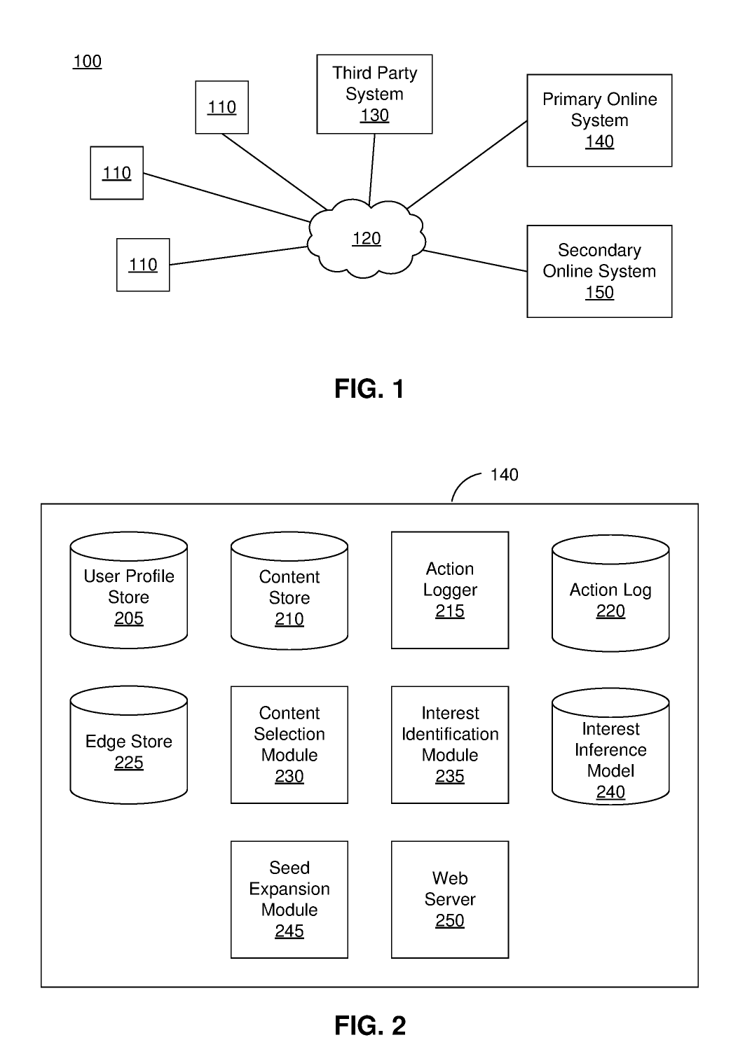

FIG. 1 is a block diagram of a system environment 100 for a primary online system 140. The system environment 100 shown by FIG. 1 comprises one or more client devices 110, a network 120, one or more third-party systems 130, a primary online system 140, and a secondary online system 150. In alternative configurations, different and/or additional components may be included in the system environment 100. For example, the primary online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the primary online system 140. For example, a client device 110 executes a browser application to enable interaction between the client device 110 and the primary online system 140 via the network 120. In another embodiment, a client device 110 interacts with the primary online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the primary online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the primary online system 140, such as advertisements, content, or information about an application provided by the third party system 130.

FIG. 2 is a block diagram of an architecture of the primary online system 140, according to one embodiment. The primary online system 140 shown in FIG. 2 includes a user profile store 205, a content store 210, an action logger 215, an action log 220, an edge store 225, a content selection module 230, an interest identification module 235, an interest inference model 240, a seed expansion module 245, and a web server 250. In other embodiments, the primary online system 140 may include additional, fewer, or different components for various applications. Conventional components such as network interfaces, security functions, load balancers, failover servers, management and network operations consoles, and the like are not shown so as to not obscure the details of the system architecture. The secondary online system 150 is similar in functionality to the primary online system 140. For example, the secondary online system 150 may include components similar to the user profile store 205, the content store 210, the action logger 215, the action log 220, the edge store 225, and the web server 250 of the primary online system 140 described below.

Each user of the primary online system 140 is associated with a user profile, which is stored in the user profile store 205. A user profile includes declarative information about the user that was explicitly shared by the user and may also include profile information inferred by the primary online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the primary online system 140, user profiles may also be stored for entities such as public figures, businesses or organizations. This allows an entity to establish a presence on the primary online system 140 for connecting and exchanging content with other online system users. The entity may post information about itself, about its products or provide other information to users of the primary online system 140 using a brand page associated with the entity's user profile. Other users of the primary online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the primary online system 140, events, groups or applications. In some embodiments, objects are received from third-party applications or third-party applications separate from the primary online system 140. In one embodiment, objects in the content store 210 represent single pieces of content, or content “items.” Hence, online system users are encouraged to communicate with each other by posting text and content items of various types of media to the primary online system 140 through various communication channels. This increases the amount of interaction of users with each other and increases the frequency with which users interact within the primary online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the primary online system 140 if content in the content item is presented to a user, if the content in the content item receives a user interaction when presented, or if any suitable condition is satisfied when content in the content item is presented to a user. For example, the bid amount included in a content item specifies a monetary amount that the primary online system 140 receives from a user who provided the content item to the primary online system 140 if content in the content item is displayed. In some embodiments, the expected value to the primary online system 140 of presenting the content from the content item may be determined by multiplying the bid amount by a probability of the content of the content item being accessed by a user.

In various embodiments, a content item includes various components capable of being identified and retrieved by the primary online system 140. Example components of a content item include: a title, text data, image data, audio data, video data, a landing page, a user associated with the content item, or any other suitable information. The primary online system 140 may retrieve one or more specific components of a content item for presentation in some embodiments. For example, the primary online system 140 may identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the primary online system 140 logs interactions between users presented with the content item or with objects associated with the content item. Additionally, the primary online system 140 receives compensation from a user associated with content item as online system users perform interactions with a content item that satisfy the objective included in the content item.

Additionally, a content item may include one or more targeting criteria specified by the user who provided the content item to the primary online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the primary online system 140. Targeting criteria may also specify interactions between a user and objects performed external to the primary online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the primary online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the primary online system 140 to track user actions on the primary online system 140, as well as actions on third party systems 130 that communicate information to the primary online system 140. Users may interact with various objects on the primary online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the primary online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the primary online system 140 as well as with other applications operating on the primary online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the primary online system 140. For example, an e-commerce website may recognize a user of a primary online system 140 through a social plug-in enabling the e-commerce website to identify the user of the primary online system 140. Because users of the primary online system 140 are uniquely identifiable, e-commerce websites, such as in the preceding example, may communicate information about a user's actions outside of the primary online system 140 to the primary online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the primary online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the primary online system 140, such as expressing interest in a page on the primary online system 140, sharing a link with other users of the primary online system 140, and commenting on posts made by other users of the primary online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the primary online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the primary online system 140 over time to approximate a user's interest in an object or in another user in the primary online system 140 based on the actions performed by the user. A user's affinity may be computed by the primary online system 140 over time to approximate the user's interest in an object, in a topic, or in another user in the primary online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the primary online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the primary online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the primary online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users that are not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the primary online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

The interest identification module 235 applies machine learning techniques to generate an interest inference model 240 that outputs indications of whether the users have one or more target interests based on their user profile in the primary online system 140. As part of the generation of the interest inference model 240, the interest identification module 235 forms a training group of users by identifying a positive training set of users that have been determined to have the one or more target interests. In some embodiments, the interest inference model 240 also uses a negative training set of users that lack the target interests.

The interest identification module 235 extracts feature values from the users of the training group, the features being variables deemed potentially relevant to whether or not the users have the one or more target interests. Specifically, the feature values extracted by the interest identification module 235 can include user profile information, and user actions. An ordered list of the features for a user is herein referred to as the feature vector for the content item. In one embodiment, the interest identification module 235 applies dimensionality reduction (e.g., via linear discriminant analysis (LDA), principle component analysis (PCA), or the like) to reduce the amount of data in the feature vectors for content items to a smaller, more representative set of data.

The interest identification module 235 uses supervised machine learning to train the interest inference model 240, with the feature vectors of the positive training set serving as the inputs. Different machine learning techniques—such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps—may be used in different embodiments. The interest inference model 240, when applied to the feature vector for a user, outputs an indication of whether the user has the one or more target interests, such as a Boolean yes/no estimate, or a scalar value representing a probability.

In some embodiments, a validation set is formed of additional users, other than those in the training sets, which have already been determined to have or to lack the target interests. The interest identification module 235 applies the trained validation interest inference model 240 to the users of the validation set to quantify the accuracy of the interest inference model 240. Common metrics applied in accuracy measurement include: Precision=TP/(TP+FP) and Recall=TP/(TP+FN), where precision is how many the interest inference model 240 correctly predicted (TP or true positives) out of the total it predicted (TP+FP or false positives), and recall is how many the interest inference model 240 correctly predicted (TP) out of the total number of content items that did have the property in question (TP+FN or false negatives). The F score (F-score=2*PR/(P+R)) unifies precision and recall into a single measure. In one embodiment, the interest identification module 235 iteratively re-trains the interest inference model 240 until the occurrence of a stopping condition, such as the accuracy measurement indication that the model is sufficiently accurate, or a number of training rounds having taken place.

The seed expansion module 245 identifies an expanded group of users that have similar characteristics to those of a seed group of users. In one embodiment, the seed expansion module 245 uses a lookalike expansion technique based on a cluster model that has been trained to determine a measure of similarity between characteristics of users and a seed group of users. The trained cluster model is applied to characteristics of a user to generate a cluster score for the user, and the seed expansion module 245 determines whether the user is included in the cluster group based on the cluster scores determined from application of the trained cluster model. For example, if the cluster score determined from application of the trained cluster model to the characteristics of a user equals or exceeds a threshold value, the user is included in the cluster group associated with the trained cluster model. This expansion method is further described in U.S. patent application Ser. No. 13/297,117, filed on Nov. 15, 2011; U.S. patent application Ser. No. 14/290,355, filed on May 29, 2014; and U.S. patent application Ser. No. 14/616,543, filed on Feb. 6, 2015; which are hereby incorporated by reference in their entirety.

The web server 250 links the primary online system 140 via the network 120 to the one or more client devices 110, as well as to the one or more third party systems 130. The web server 250 serves web pages, as well as other content, such as JAVA®, FLASH®, XML and so forth. The web server 250 may receive and route messages between the primary online system 140 and the client device 110, for example, instant messages, queued messages (e.g., email), text messages, short message service (SMS) messages, or messages sent using any other suitable messaging technique. A user may send a request to the web server 250 to upload information (e.g., images or videos) that are stored in the content store 210. Additionally, the web server 250 may provide application programming interface (API) functionality to send data directly to native client device operating systems, such as IOS®, ANDROID®, WINDOWS®, or BlackberryOS.

### Method for Targeting Content Using Inferred Interests

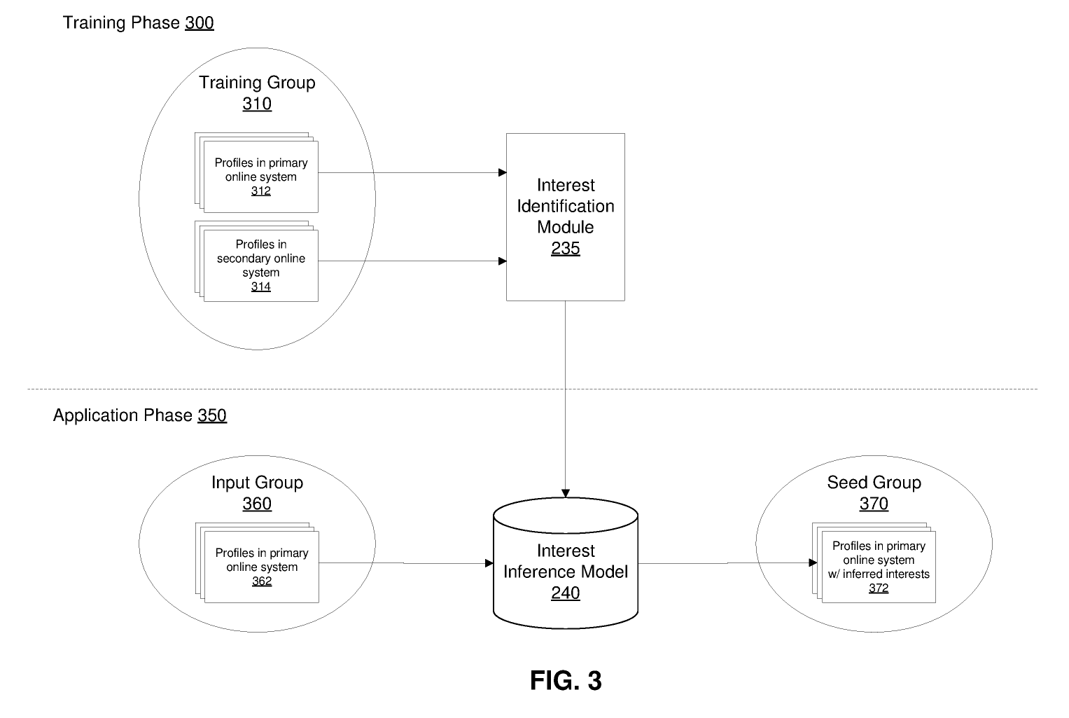

FIG. 3 illustrates a training phase 300 and an application phase 350 of the machine-learned interest inference model 240 for inferring user interests in the primary online system 140 based on known interests in the secondary online system 150, according to one embodiment. During the training phase 300, the interest identification module 235 trains the interest inference model 240 based on a training group of users 310 known to have a particular target interest. The interest inference model 240 is then applied to an input group of users 360 during the application phase 350 to identify a subset of the input group 360 as a seed group of users 370 for whom the target interest can be inferred.

In the training phase 300, the interest identification module 235 develops the interest inference model 240 for a particular target interest using a training group of users 310 that are known to have the target interest and thus form a positive training set. Each user of the training group 310 is a user of both the primary online system 140 and the secondary online system 150, and is associated with the target interest in the secondary online system 150. As users of both the primary online system 140 and the secondary online system 150, the users of the training group 310 have user profiles 312 in the primary online system 140 and user profiles 314 in the secondary online system 150. The association between the users of the training group 310 and the target interest may be reflected in the user profiles 314 in the secondary system 150 such that the user profiles 314 include the target interest. The target interest may have been explicitly provided to the secondary online system 150 by the user (e.g., typed into an “interests” field), implicitly provided (e.g., the user “likes” a page of the secondary online system 150 that is associated with the target interest) or inferred by the secondary online system 150 through another method.

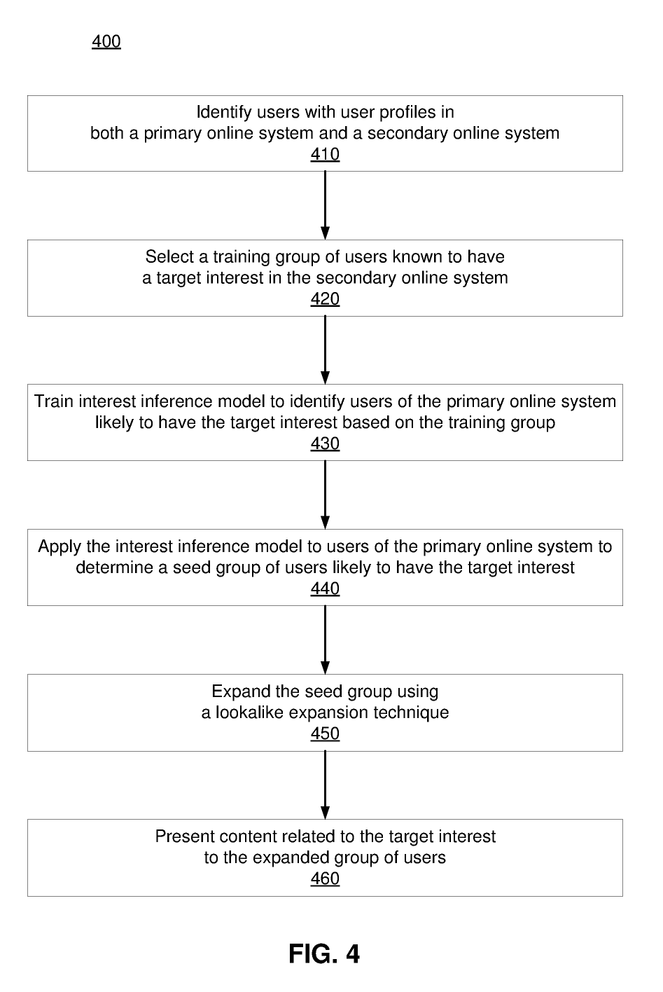

Once the training group 310 is identified, machine learning techniques are applied to them in order to determine user characteristics that correspond to the target interest. The interest identification module 235 considers user characteristics from the user profiles 312 in the primary online system 140, and in some embodiments, also considers user characteristics from the user profiles 314 in the secondary online system 150. Developing the interest inference model 240 based on the training group 310 is discussed in further detail in conjunction with step 430 of FIG. 4.

In the application phase 350, the primary online system 140 applies the interest inference model 240 to an input group of users 360 who have user profiles 362 in the primary online system 140. The result of the application of the interest inference model 240 is a seed group of users 370, who are users from the input group 360 for whom the target interest can be inferred. In some embodiments, the target interest is added to the user profiles 372 of the seed group 370 in the primary online system 140. Application of the interest inference model 240 is discussed in further detail in conjunction with step 440 of FIG. 4. The primary online system 140 uses the seed group 370 to generate an expanded group of users to which it targets content based on the inferred interest, which is further discussed in conjunction with steps 450-460 of FIG. 4.

FIG. 4 is a flow chart of a process 400 for presenting content to users of the primary online system 140 based on inferred interests, according to one embodiment. In some embodiments, the primary online system 140 does not perform all of the steps of process 400. For example, the primary online system 140 may not expand 460 the seed group 370 before presenting 470 targeted content, or it may only infer interests and not go so far as to present 470 targeted content. Process 400 may also include additional steps that are not described below.

The primary online system 140 first identifies 410 users that have user profiles in (i.e., are users of) both the primary online system 140 and the secondary online system 150. In one embodiment, the interest identification module 235 receives a group of users that already have their user profiles in the primary online system 140 and their user profiles in the secondary online system 150 already linked or otherwise identified as belonging to the same users. In another embodiment, the primary online system 150 identifies and pairs the user profiles. Users of the primary online system 140 may be identified as users of the secondary online system 150 by comparing information in their user profiles. This information may include names, birthdates, email addresses, phone numbers, addresses, job positions or workplaces, education, usernames or connections to other online systems, or other demographic or personal information (such as that described in conjunction with the user profile store 205 of FIG. 2). For example, User A's user profile in the primary online system 140 includes an email address “piper@cutedogs.com” and User B's user profile in the secondary online system 150 also includes the email address “piper@cutedogs.com,” so the primary online system 140 links User A's user profile in the primary online system 140 with User B's user profile in the secondary online system 150. In some embodiments, the user profiles in the primary online system 140 and the secondary online system 150 may be explicitly linked by the user. For example, the user may have created their account in the primary online system 140 using their account in the secondary online system 150 (or vice versa).

From these users with user profiles in both online systems 140 and 150, the primary online system 140 selects 420 a training group of users 310 who are known to have a particular target interest in the secondary online system 150, such as by the target interest being included in their user profiles 314 in the secondary online system 150. The primary online system 140 may determine which target interests it wants to infer for its users based on its value to the primary online system 140. For example, the primary online system 140 may want to increase the number of users associated with interests that have higher conversion rates or otherwise associated with more user interactions when used as a targeting criteria. In some embodiments, the primary online system 140 wants to infer a set of target interests rather than just a single target interest, so the training group 310 is made up of users that have all of the target set of interests in the secondary online system 150.

Using the training group 310, the primary online system 140 trains 430 the interest inference model 240 to identify users of the primary online system 140 who are likely to have the target interest. The training is done via machine learning techniques described in conjunction with the interest identification module 235 of FIG. 2, associating features of the training group 310 with the target interest. Besides the user profile information and user actions discussed in conjunction with FIG. 2, these features can include hashtags, topics, or other labels associated with content for which the user has expressed a positive preference; pages or other user accounts that the user is associated with; comments by the user; views or visits to a profile or page by the user; and search queries and data from subsequent clicks. The primary online system 140 can also use information about topical authorities, which are user accounts that are strongly tied to particular topics or interests and often are subscribed to (or “followed”) by many users. Specifically, the primary online system 140 can use whether a user follows a topical authority for the target interest as a feature. For users with little information in their user profiles, the primary online system 140 may propagate features from other users that have a strong connection to the user (i.e., other users that have high affinity scores).

In some embodiments, features are also sourced from the secondary online system 150. For example, user profile and user action information from user profiles in the secondary online system 150 may be used as features. The primary online system 140 may also map pages or user accounts that the user in the primary online system 140 is associated with (e.g., by subscribing to, expressing a preference for, or interacting with content provided by them) to those in the secondary online system 150 and use topics or characteristics associated with the page or user account in the secondary online system 150 as features. However, features sourced directly from user profiles in the secondary online system 150 may be weighted different when the interest inference model 240 is applied so that it does not bias the model against users that are not also users of the secondary online system 150, or are relatively inactive users of the secondary online system 150.

In many embodiments, there are a lot of potential features available to the primary online system 140 for inclusion in the interest inference model 240. The primary online system 140 can intelligently select features for the interest inference model 240 for greatest applicability and minimal biasing. Specifically, the primary online system 140 can select features that avoid biasing against users that are not users of the secondary online system 150 or have minimal activity in the secondary online system 150. These features may include, for example, likes and accounts followed in the primary online system 140.

The primary online system 140 applies 440 the interest inference model 240 to an input group of users to determine a seed group of users 370 who are likely to have the target interest. In some embodiments, the input group 360 is the entire user population of the primary online system 140, while in others it may be users that meet other targeting criteria. In some embodiments, users of the input group 360 can be selected to be part of the seed group 370 based on a threshold probability that they have the target interest. That is, the interest inference model 240 outputs a probability that a particular user in the input group 360 has the target interest, and if that probability is above the threshold probability, they are selected to be part of the seed group 370. Alternatively, the seed group 370 may be constrained to a predetermined number of users from the input group 360, or a predetermined proportion of the input group 360. Generation of the seed group 370 may be subject to other constraints, such as a number or proportion minimum or cap (rather than a specific value). For example, the seed group 370 may be required to be less than 50% of the input group 360.

In some embodiments, the primary online system 140 receives and incorporates user feedback about interests inferred by the interest inference model 240. User feedback can be solicited via surveys explicitly asking the user whether they have the target interest. User feedback can also be implicitly received from the user, such as if they add the interest to their profile or request to stop receiving content associated with the interest. This feedback can be used to rework the interest inference model 240, for example strengthening the association between the characteristics of the user and the target interest if the feedback indicates that they do have the interest, or weakening that association if the feedback indicates that they do not have the interest.

The primary online system 140 expands 450 the seed group to generate an expanded group of users using a lookalike expansion technique, such as that discussed in conjunction with the seed expansion module 245. Like the seed group 370, the expanded group may be subject to various constraints, including a threshold level of similarity, a predetermined number of users, or a predetermined proportion of users relative to the seed group 370, or even the input group 360 in some embodiments. In some embodiments, the primary online system 140 adds the inferred interest to the user profiles of the expanded group, while in others, it only adds the inferred interest to those of the seed group 370. Based on the newly inferred interest, the primary online system 140 can present 460 targeted content related to the target interest to users of the expanded group. In some embodiments, the primary online system 140 weights inferred interests less than explicit interests when selecting targeted content for users.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
identifying a plurality of users having a first user profile in a primary online system and a second user profile in a secondary online system, the second user profile including one or more interests of the user;
selecting a training group of users from the identified plurality of users, each user of the training group of users having a target interest as one of the one or more interests included in the second user profile in the secondary online system;
training an interest inference model with the training group of users to infer the target interest for a plurality of users in the primary online system based a plurality of features from their user profile in the primary online system; and
identifying a seed group of users in the primary online system likely to have the target interest by applying the trained interest inference model to users of the primary online system.

2. The method of claim 1, further comprising:
expanding the seed group of users in the primary online system via using a lookalike expansion technique;
presenting content related to the target interest to the expanded group of users in the primary online system.

3. The method of claim 1, wherein one or more users of the seed group of users does not have a user profile in the secondary online system.

4. The method of claim 1, wherein at least one user of the seed group of users has a user profile in the secondary online system but the user profile does not include the target interest.

5. The method of claim 1, wherein the plurality of features includes whether the user follows a topical authority account strongly associated with the target interest in the primary online system.

6. The method of claim 1, wherein the plurality of features includes demographic information.

7. The method of claim 1, wherein the plurality of features includes user activity on both the primary online system and the secondary online system.

8. The method of claim 1, wherein the seed group of users is a predetermined proportion of an input group of users.

9. The method of claim 8, wherein the predetermined proportion is less than 50%.

10. The method of claim 8, wherein the input group of users is the user population of the primary online system.

11. A computer program product comprising a non-transitory computer-readable storage medium containing computer program code for:
identifying a plurality of users having both a first user profile in a primary online system and a second user profile in a secondary online system, the second user profile including one or more interests of the user;
selecting a training group of users from the identified plurality of users, each user of the training group of users having a target interest as one of the one or more interests included in the second user profile in the secondary online system;
training an interest inference model with the training group of users to infer the target interest for a plurality of users in the primary online system based a plurality of features from their user profile in the primary online system; and
identifying a seed group of users in the primary online system likely to have the target interest by applying the trained interest inference model to users of the primary online system.

12. The computer program product of claim 11, further comprising:
expanding the seed group of users in the primary online system using a lookalike expansion technique;
presenting content related to the target interest to the expanded group of users in the primary online system.

13. The computer program product of claim 11, wherein one or more users of the seed group of users does not have a user profile in the secondary online system.

14. The computer program product of claim 11, wherein at least one user of the seed group of users has a user profile in the secondary online system but the user profile does not include the target interest.

15. The computer program product of claim 11, wherein the plurality of features includes whether the user follows a topical authority account strongly associated with the target interest in the primary online system.

16. The computer program product of claim 11, wherein the plurality of features includes demographic information.

17. The computer program product of claim 11, wherein the plurality of features includes user activity on both the primary online system and the secondary online system.

18. The computer program product of claim 11, wherein the seed group of users is a predetermined proportion of an input group of users.

19. The computer program product of claim 18, wherein the predetermined proportion is less than 50%.

20. The computer program product of claim 18, wherein the input group of users is the user population of the primary online system.
